(19) United States
(12) Patent Application Publication
(10) Pub. No.: US 2013/0103964 A1
(43) Pub. Date: Apr. 25, 2013

(54) Device and method for the reliable detection of wakeup events in the shutdown phase of a control unit

(71) Applicant: Robert Bosch GmbH, Stuttgart (DE)

(72) Inventors: Wolfgang PEVELING, Backnang (DE); Patrick Renner-Ivenz, Bad Rappenau (DE)

(73) Assignee: Robert Bosch GmbH, Stuttgart (DE)

(21) Appl. No.: 13/624,506

(22) Filed: Sep. 21, 2012

(30) Foreign Application Priority Data
Oct. 21, 2011 (DE) 10 2011 084 963.7

(51) Int. Cl. G06F 1/30

(52) U.S. Cl. CPC G06F 1/305
USPC 713/323

(57) ABSTRACT

A wakeup logic element for providing reliable detection of wakeup events in the shutdown phase of a control unit for a vehicle, having a wakeup source input, the wakeup source input being implemented as a flank-sensitive wakeup input, and an on/off state of a vehicle control unit being controllable by the wakeup source input, wherein a wakeup signal which arrives at the wakeup source input during a shutdown procedure of the control unit is able to be delayed or temporarily suppressed, such that the wakeup signal is applied at the wakeup source input after the control unit has been shut down.

### RELATED APPLICATION INFORMATION

The present application claims priority to and the benefit of German patent application no. 10 2011 084 963.7, which was filed in Germany on Oct. 21, 2011, the disclosure of which is incorporated herein by reference.

### FIELD OF THE INVENTION

The present invention relates to automotive control units in general. More specifically, the present invention relates to the restarting of control units which receive a wakeup event in the shutdown phase of the control unit. The present invention further relates to a wakeup logic element for the reliable detection of wakeup events in the shutdown phase of a control unit for a vehicle; it also relates to a control unit for a vehicle provided with a wakeup logic element according to the present invention, to a vehicle, in particular an automobile having a wakeup logic element according to the present invention, and/or to a control unit according to the present invention, as well as to a method for the reliable detection of wakeup events in the shutdown phase of a control unit.

### BACKGROUND INFORMATION

Control units in a vehicle, such as an automobile, may be activated or deactivated mainly by operating the ignition key. In other words, when the ignition of the vehicle is operated, i.e., the ignition circuit is closed and supplied with energy, or when the ignition circuit is opened, control units are supplied with, or cut off from, the supply voltage.

Due to the ever increasing networking as well as comfort and supplementary functionalities in the vehicle, however, the number of components or control units that require an activation, possibly only at a partial functionality, even prior to operating the ignition key, or that are meant to continue running for a specific period of time after the ignition has been switched off, is rising. Such an early activation or delayed deactivation may be accomplished via vehicle-bus activity or a signal line of a central control unit.

This results in multiple activation or deactivation options for components such as control units in a vehicle, e.g., the use of multiple wakeup sources. The ignition may serve as primary wakeup source in this context, and the vehicle bus and/or additional, possibly discrete signal lines may act as secondary wakeup sources.

The primary wakeup source is able to keep the control unit permanently active. It may thus be powered off only when the primary wakeup source is no longer active, i.e, when the ignition is switched off in the case of the ignition, for instance. If the ignition serves as primary wakeup source, this behavior is unproblematic.

Secondary wakeup sources, however, which are able to activate a control unit or keep it activated even if the ignition is no longer active, may endanger the availability of the vehicle in the event of a fault in the signal chain of the wakeup source. For example, it is possible that the activated control unit drains the battery of the vehicle, possibly even to such an extent that the battery is unable to supply sufficient energy to start the vehicle.

If a primary wakeup source or a primary wakeup source input is mentioned in the further course of the description, then this is to be understood as a level-sensitive or level-controlled wakeup source or a level-sensitive or level-controlled wakeup source input, in particular. If a secondary wakeup source or a secondary wakeup source input is mentioned in the further course of the description, then this is to be understood as a flank-sensitive or flank-controlled wakeup source or a flank-sensitive or flank-controlled wakeup source input, in particular.

### SUMMARY OF THE INVENTION

Thus, it may be advantageous to configure a control unit or a control unit element actuating the control unit in such a way that it is able to be shut down even if the secondary wakeup source is active.

Accordingly, a wakeup logic element for the reliable detection of wakeup events in the shutdowm phase of a control unit for a vehicle, a control unit for a vehicle, a vehicle, and a method for the reliable detection of wakeup events in the shutdowm phase of a control unit according to the independent patent claims are provided. Refinements of the exemplary embodiments and/or exemplary methods of the present invention are derived from the further descriptions herein.

One aspect of the exemplary embodiments and/or exemplary methods of the present invention may be seen in the fact that only the flank of a wakeup signal, that is to say, the transition of the state at a wakeup input, is analyzed as wakeup event. In other words, the transition of a logic signal from “1” to “0” or vice versa, but not the state “1” or “0” itself, that is to say, a level of a wakeup signal, may be considered a wakeup event.

However, such a wakeup signal may be transmitted at any point in time and be received in a control unit or an upstream wakeup logic element. In such a case it may be problematic, in particular, that an arriving wakeup event is received during the shutdown procedure of a control unit and thus possibly cannot be analyzed to the effect that the control unit is either started up again or kept active altogether.

This may be due to the fact that, prior to the final shutdown of the control unit, the logic of a control unit needs to check whether a wakeup source is active and the control unit should not to be shut down for that reason. This results in a time window between this check and the actual shutdown of the control unit. If a wakeup signal in the form of a state change of a logic signal then arrives at the wakeup input during this time window, this wakeup event may be lost. As a result, the control unit would now be shut down, notwithstanding a signal that should cause the renewed startup of the control unit.

If such a wakeup event is not repeated, for instance after a particular time interval that would definitely arrive following the longest possible shutdown period of the control unit, the control unit remains in the shutdown state.

One aspect of the exemplary embodiments and/or exemplary methods of the present invention thus may be that the loss of a wakeup event in such a shutdown phase of a control unit is to be prevented.

In a potential worst-case scenario of the situation just described, the control unit thus is either not active, or possibly active only following multiple wakeup events, and perhaps too late, and it is therefore possible that a requested functionality is not provided. The exemplary embodiments and/or exemplary methods of the present invention are intended to prevent this situation and, regardless of an instant at which a wakeup event arrives, reliably ensures that this wakeup event is definitely detected, and the control unit thus is activated or remains activated in reliable manner.

As a result, the exemplary embodiments and/or exemplary methods of the present invention also relate to a wakeup logic element for the reliable detection of wakeup events in the shutdown phase of a control unit for a vehicle, which has a primary wakeup source input and a secondary wakeup source input, the primary wakeup source input having priority over the secondary wakeup source input; an on/off state of a vehicle control unit being controllable by the primary wakeup source input and the secondary wakeup source input, wherein the secondary wakeup source input is developed as a flank-sensitive wakeup input.

Specific embodiments of the present invention are represented in the drawing and more closely explained in the description below.

### BRIEF DESCRIPTION OF THE DRAWINGS

FIG. 1 shows a schematic representation of a wakeup logic element according to the present invention.

FIGS. 2a and 2b show an exemplary level characteristic of the wakeup logic element from FIG. 1.

FIG. 3 shows the method for the reliable detection of wakeup events according to the present invention.

### DETAILED DESCRIPTION

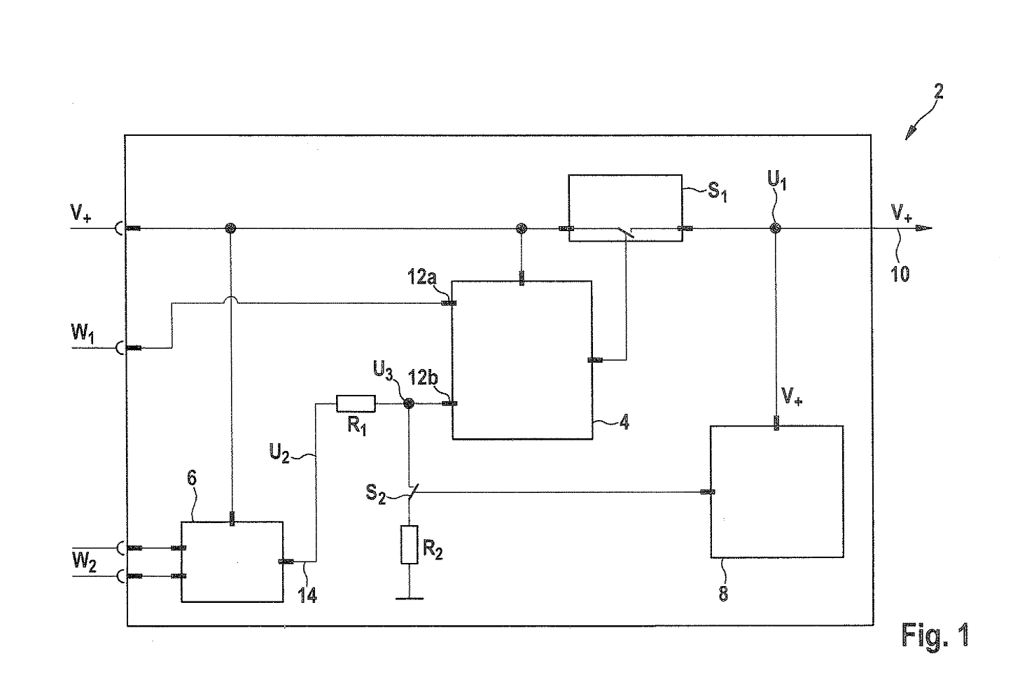

FIG. 1 shows a schematic representation of a wakeup logic element according to the present invention.

FIG. 1 shows a wakeup logic element 2 for a vehicle, which first of all is connected to voltage supply V+, e.g., the 12V battery voltage of a vehicle having a continuous supply. By way of example, wakeup logic element 2 has a primary wakeup source W1, e.g., the vehicle ignition, as well as a secondary wakeup source W2, represented in the form of two bus inputs, e.g., a CAN bus or a FlexRay bus, or it is connected thereto.

Primary wakeup source WI is connected to a wakeup logic element 4, especially to its level-sensitive wakeup input 12a. In other words, at the moment when primary wakeup source W1 forwards a defined level signal to level-sensitive wakeup input 12a, the wakeup logic is permanently active, in such a way that switch S1, due to its closed state, forwards supply voltage V+ via output 10 to a downstream control unit (not shown further). Wakeup logic element 2 may likewise be part of a control unit for a vehicle. In this case it is possible to omit output 10, or it may be routed internally in the control unit and be used to supply energy to the control unit.

By way of example, a wakeable bus transceiver element 6 which is configured to analyze a wakeup signal received via a communication bus is connected to secondary wakeup source W2. If wakeup source W2 already supplies an adequate, suitable wakeup signal on its own, wakeable transceiver 6 may be dispensed with. Both wakeup logic element 4 and wakeable bus transceiver 6 are connected to voltage supply V+ for the supply of operating energy.

If wakeup source W2 forwards a wakeup signal to wakeable bus transceiver 6, bus transceiver 6 may apply supply voltage V+, e.g., 12V in the form of U2, at a switching output 14, or switch it through. Via resistor R1, such as a decoupling resistor, switching output 14 is connected to a flank-sensitive wakeup input 12b of wakeup logic element 4.

Routed to ground, a further switching element S2, which is connected to ground either directly or else via resistor R2, is situated between resistor R1 and flank-sensitive wakeup input 12b. In other words, R2 may likewise be 0 Ohm, and thus be a pure short circuit.

Controller element 8 controls switch 92. In the uncontrolled state, or in the event that controller element 8 is deactivated, e.g., due to the lack of an operating voltage supply, switch 92 is open.

According to the exemplary embodiments and/or exemplary methods of the present invention, a secondary wakeup event arrives via secondary wakeup source W2, is connected to switching output 14 via wakeable bus transceiver 6, and reaches wakeup logic element 4 in this way. The rising flank on switching output 14, and thus the wakeup event, is delayed or suppressed until the control unit has been shut down. Once the control unit has been shut down, the delayed or suppressed flank of the wakeup signal on switching output 14 is forwarded to flank-sensitive wakeup input 12b of wakeup logic element 4, and the control unit is reactivated in this manner.

An ESP control unit with the ignition as primary wakeup source W1 and vehicle bus FlexRay as secondary wakeup source W2 is described by way of example and with reference to FIG. 1. The following comments reflect this example, but the exemplary embodiments and/or exemplary methods of the present invention are able to be used in all control units that provide secondary wakeup sources with flank-sensitive control.

Switching output 14 is decoupled from flank-sensitive wakeup input 12b of wakeup logic element 4 via series resistor R1. In the open position, switch 92, controlled by controller element 8, leaves flank-sensitive wakeup input 12b unaffected, while in the closed state, i.e., the short circuit of the flank-sensitive wakeup input to ground or via resistor R2, the wakeup signal on switching output 14 is suppressed.

In the process, using controller element 8, switch 82 is connected in such a way that, in the currentless state, e.g., with deactivated controller element 8, it is in position 1, in other words, in the open position. Controller element 8 is connected to supply voltage V+, which drops when the control unit or its (upstream) wakeup logic element 2 is shut down by opening switch S1.

Directly prior to a shutdown process, the activity of wakeup input W2 is checked. If it is not active, switch S2 is brought into closed position 2, so that a potential U3 is connected to ground and thus shunted away, possibly via resistor R2. This suppresses a wakeup event possibly arriving via switching output 14.

The control unit is subsequently shut down by opening switch S1. Following the shutdown, switch 82 returns to its basic position, position 1, i.e., the open position. In the event that a wakeup flank has since been received via wakeup source W2, i.e., in the shutdown period between an activity check at wakeup input 12b and the final shutdown of the control device, was forwarded to wakeup logic element 4 via wakeup source W2 and thus has arrived in front of decoupling resistor R1, a flank at flank-sensitive wakeup input 12b of wakeup logic element occurs once switch S2 has dropped back into its open state. Wakeup logic element 4 detects the arrival of this wakeup signal and actuates switch S1 again such that the control unit is supplied with supply voltage V+ once again, via output 10, and thus returns to the wake mode.

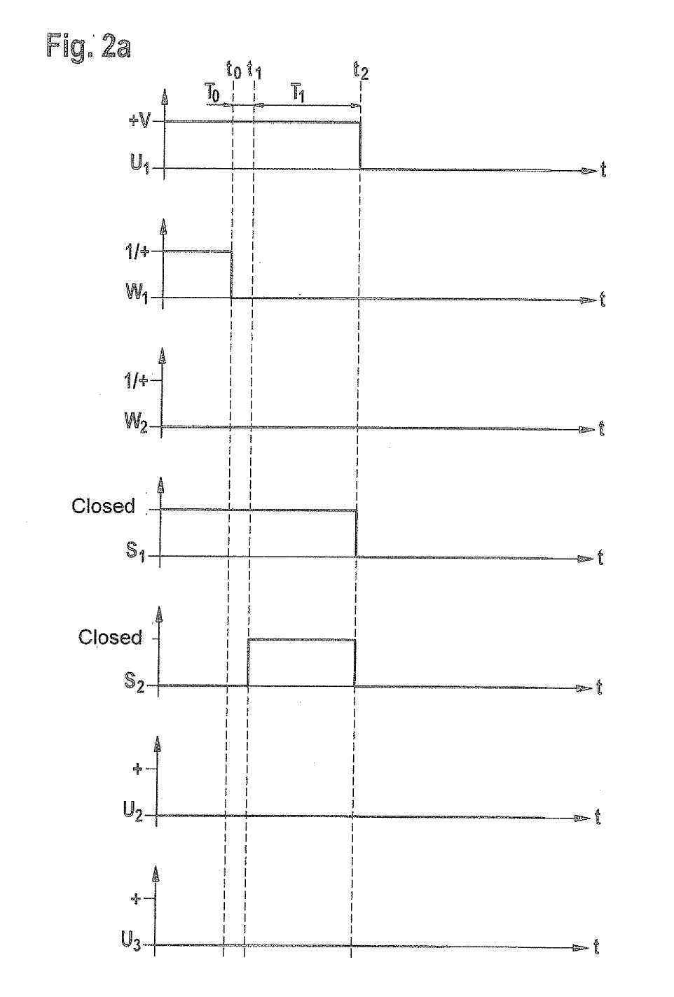

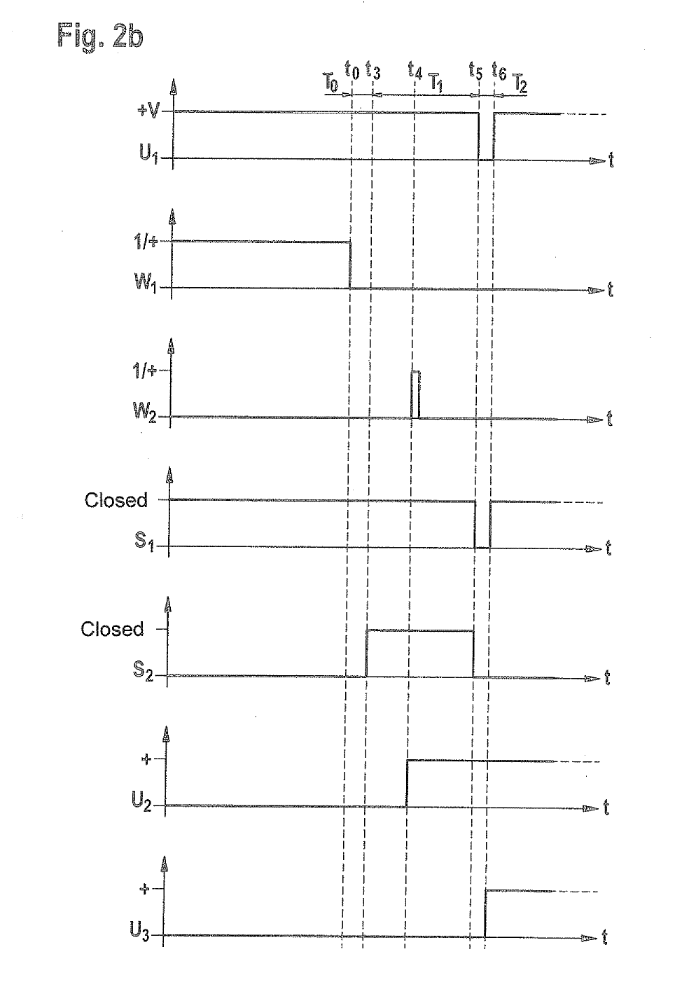

Furthermore, with reference to FIG. 2a, b, an exemplary level characteristic of the wakeup logic element of FIG. 1 is illustrated.

FIG. 2a shows a shutdown procedure without an arriving wakeup signal on W2.

In this context, wakeup signal W1, e.g., the ignition, is permanently activated until instant t₀. At this moment the ignition is deactivated, but supply voltage U1 continues to be maintained until the final shutdown of the control unit at instant t₂. Through cyclical checking of the wakeup signals, there also is a time interval T₀ between the physical state change of W1 and instant t₁ of checking W1, and the closing of switch S2.

At instant t₁ it is then checked whether wakeup input W2 supplies a signal. In the case of FIG. 2a, wakeup input E2 is not occupied, however. Switch S2 is transferred into a closed state for time interval T₁ between t₁ and t₂. In the process, switch S1 is kept closed until the control unit is finally shut down at instant t₂, and thereby continues to supply voltage U1 to an external control unit or within the control unit, in the event that wakeup logic element 2 is part of a control unit.

At final shutdown instant t₂, supply voltage U1 is switched off from the control unit by switch S1. The switching off of the supply voltage which, for controller element 8, is tapped downstream from switch S1 as well, also causes switch S2 to drop back from the closed to the open state. Since no level is applied at flank-sensitive wakeup input 12b or applied over switching output 14 upstream from R1, the opening of switch S2 does not cause any wakeup flank to be forwarded to wakeup logic element 4, and the control unit shuts down for good or remains in shutdown mode.

Furthermore, with reference to FIG. 2b, the arrival of a secondary wakeup signal W2 at the instant of shutdown T₁ is illustrated.

As explained previously, wakeup source W1 switches off at instant t₀. After a certain latency period T₀ of the cyclical checking of the wakeup sources, switch 82 is transferred into a closed state at instant t₃ and maintained in this state until instant t₅. T₁ once again is the time period of the final shutdown of the control unit.

Now, however, a wakeup signal arrives at instant t₄ via wakeup input W2. Voltage U2 is connected to switching output 14 at instant t₄, via wakeable bus transceiver element 6. Due to closed switch 52, and thus the short circuit of flank-sensitive wakeup input 12b, wakeup logic element 4 receives no wakeup signal U3 for as long as switch 52 is in the closed state.

At instant t₅, supply voltage U1 is finally decoupled from the control unit, using switch S1, and the control unit is shut down. This also removes the supply voltage for controller element 8, which causes switch S2 to drop back into an open state. At this moment, upstream from decoupling resistor R1, U2 turns into U3 downstream from the decoupling resistor. Since this causes a flank of a wakeup signal to arrive at flank-sensitive wakeup input 12b, switch S1 is closed again at instant t₆ following a processing period T₂, the control unit receives supply voltage U1 again and thus is reactivated.

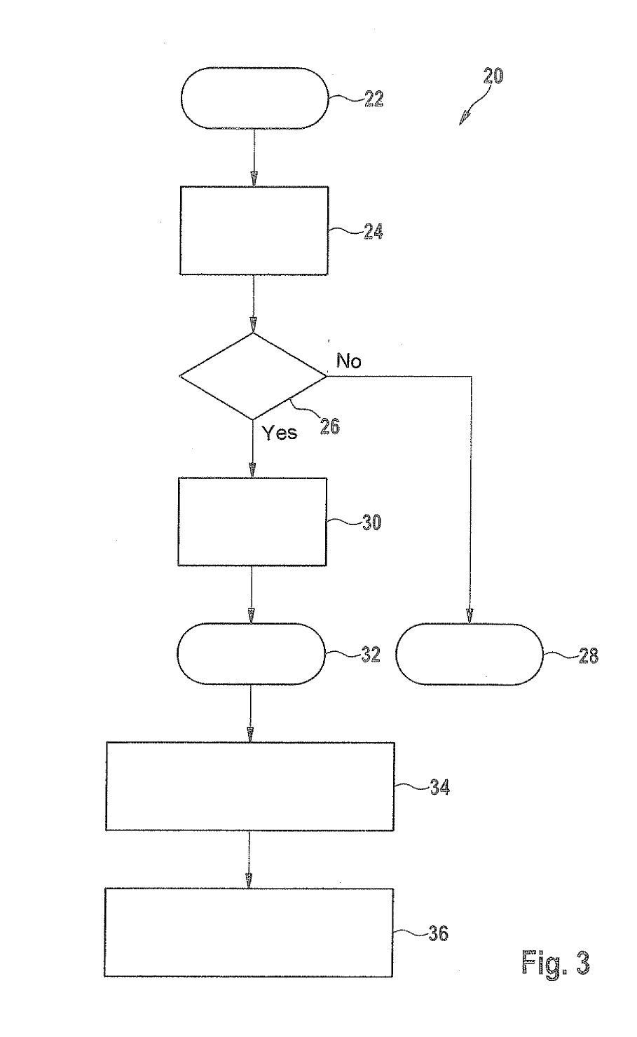

Furthermore, making reference to FIG. 3, method 20 for the reliable detection of wakeup events according to the present invention is illustrated.

The control unit initially is ready for shutdown 22 at a particular instant. Thereafter, it is checked 24 to what extent wakeup sources are still active. If it is determined that none of wakeup sources W1, W2 is active 26 any longer, a shutdown procedure for the control unit may be initiated. If it is determined that wakeup sources are still active, the control unit is not shut down 28.

If the control unit is then to be shut down, flank-sensitive wakeup input 12b is suppressed 30 or delayed to begin with. Then, the control unit is shut down, which ultimately results in the opening of switch S1. In the event that a wakeup signal has arrived via wakeup source W2, this leads to the actuation of flank-sensitive wakeup input 12b of wakeup logic element 4. This is done after flank-sensitive wakeup input 12b of controller element 8 has been enabled again by the switched-off control unit or by the supply voltage switched off by switch S1, in that switch S2 is reopened.

In the event that a wakeup event has since arrived at flank-sensitive wakeup input 12b via secondary wakeup source W2, delayed by the brief closing and reopening of switch S2 in the shutdown process of the control unit, wakeup signal U3 now applied leads to a restart of the control unit in that wakeup logic element 3 closes switch S1.

What is claimed is:

1. A wakeup logic element for providing reliable detection of a wakeup event in a shutdown phase of a control unit for a vehicle, comprising:
a wakeup source input, which includes a flank-sensitive wakeup input, wherein an on/off state of a vehicle control unit is controllable by the wakeup source input;
wherein a wakeup signal, which arrives at the wakeup source input during a shutdown process of the control unit, is able to be delayed or temporarily suppressed, such that the wakeup signal is applied at the wakeup source input following a completed shutdown of the control unit.

2. The wakeup logic element of claim 1, further comprising:
a controller element set up to delay or temporarily suppress the wakeup signal.

3. The wakeup logic element of claim 1, wherein the control unit is actuable by the delayed or temporarily suppressed wakeup signal or by a delayed or temporarily suppressed wakeup flank, such that the control unit is able to be transferred back into a switched-on state following the completed shutdown.

4. The wakeup logic element of claim 2, wherein the controller element is set up to deactivate the wakeup source input during the shutdown phase of the control unit, using a switching element, and to reactivate it again following the completed shutdown phase.

5. The wakeup logic element of claim 1, wherein the startup and shutdown of the control unit takes place by switching the supply voltage of the control unit on or off.

6. The wakeup logic element of claim 1, wherein a wakeup source at the wakeup source input is a communication bus of a vehicle.

7. A control unit for a vehicle, comprising:
a wakeup logic element for providing reliable detection of a wakeup event in a shutdown phase of a control unit for a vehicle, including:
a wakeup source input, which includes a flank-sensitive wakeup input, wherein an on/off state of a vehicle control unit is controllable by the wakeup source input;
wherein a wakeup signal, which arrives at the wakeup source input during a shutdown process of the control unit, is able to be delayed or temporarily suppressed, such that the wakeup signal is applied at the wakeup source input following a completed shutdown of the control unit.

8. A motor vehicle, comprising:
at least one of the following:
(i) at least one wakeup logic element for providing reliable detection of a wakeup event in a shutdown phase of a control unit for a vehicle, including:
a wakeup source input, which includes a flank-sensitive wakeup input, wherein an on/off state of a vehicle control unit is controllable by the wakeup source input;
wherein a wakeup signal, which arrives at the wakeup source input during a shutdown process of the control unit, is able to be delayed or temporarily suppressed, such that the wakeup signal is applied at the wakeup source input following a completed shutdown of the control unit; and
(ii) a control unit, including:
a wakeup logic element for providing reliable detection of a wakeup event in a shutdown phase of a control unit for a vehicle, including:
a wakeup source input, which includes a flank-sensitive wakeup input, wherein an on/off state of a vehicle control unit is controllable by the wakeup source input;
wherein a wakeup signal, which arrives at the wakeup source input during a shutdown process of the control unit, is able to be delayed or temporarily suppressed, such that the wakeup signal is applied at the wakeup source input following a completed shutdown of the control unit.

9. A method for providing a reliable detection of a wakeup event in a shutdown phase of a control unit, the method comprising:
detecting a scheduled shutdown process of a control unit;
suppressing a possible wakeup signal until the end of the shutdown process of a control unit; and
canceling the suppression of the possible wakeup signal.

10. The method of claim 9, further comprising:
detecting a possible wakeup signal following a completed shutdown process of the control unit; and
starting up the control unit if a wakeup signal has been detected.

11. The wakeup logic element of claim 1, wherein a wakeup source at the wakeup source input is a communication bus of a vehicle, and wherein the communication bus is a CAN bus or a FlexRay bus.

12. The wakeup logic element of claim 1, wherein a wakeup source at the wakeup source input includes a signal transmitted by a communication bus.

13. The wakeup logic element of claim 1, wherein a wakeup source at the wakeup source input includes a signal transmitted by a communication bus, wherein the communication bus is a CAN bus or a FlexRay bus.
